(19) United States
(12) Patent Application Publication
(10) Pub. No.: US 2009/0178865 A1
(43) Pub. Date: Jul. 16, 2009

(54) Bag, case, trolley case and the like

(75) Inventor: Bottino Marcello, Genova (IT)

Correspondence Address: HEDMAN & COSTIGAN P.C., 1185 AVENUE OF THE AMERICAS, NEW YORK, NY, 10036, US

(73) Assignee: ORANGE S.R.L., Genova (IT)

(21) Appl. No.: 12/321,104

(22) Filed: Jan. 15, 2009

(30) Foreign Application Priority Data
Jan. 16, 2008 (IT) MI2008U-000010

(51) Int. Cl. B62M 23/00; B60K 7/00

(52) U.S. Cl. 180/55

(57) ABSTRACT

An improved bag, case, trolley case and the like comprises a containing body including wheels for displacing the containing body, wherein to at least a wheel is coupled an electric current generator, for power supplying at least an electric component.

### BACKGROUND OF THE INVENTION

The present invention relates to an improved bag, case, trolley case and the like.

As is known, in a journey or trip event, it would be advantageous to have available an electric current source to power supply several electronic devices, such as playback, computer and wireless phone devices.

Prior solutions, however, do not allow a user to easily access a power supply source, with the exception of some modern applications providing a user with a capability of accessing electric sockets on transport means such as trains, airplanes and so on.

Thus, in a normal situation, the user may access an electric power source only on board of a motor vehicle, on which it is possible to perform a connection to the motor vehicle battery through an electric lighter socket.

### SUMMARY OF THE INVENTION

Thus, the aim of the present invention is to solve the above disclosed problem, by providing an improved bag, case, trolley case and the like, providing a user with the possibility of accessing an electric source to power supply electric or electronic devices in general, without using specifically designed implements or tools which could hinder said user.

Within the scope of the above aim, a main object of the present invention is to provide such an improved bag, case, trolley case allowing a user to quickly and easily power supply lighting instruments, radio controllers, radio emitters for telecontrolling apparatus and the like.

Another object of the present invention is to provide such an improved bag, case, trolley case and the like, which is construction-wise similar to conventional trolley cases, without requiring specifically designed fittings or modifications.

Yet another object of the present invention is to provide such a trolley case which, owing to its specifically designed construction, is very reliable and safe in operation.

Yet another object of the present invention is to provide such a bag, case, trolley case and the like which can be easily made and which, moreover, is very competitive from a mere economic standpoint.

According to one aspect of the present invention, the above mentioned aim and objects, as well as yet other objects, which will become more apparent hereinafter, are achieved by an improved bag, case, trolley case comprising a containing body including a plurality of transfer wheels, and being characterized in that said bag, case, trolley case further comprises, coupled to at least a said transfer wheel, an electric current generator for power supplying at least an electric component.

### BRIEF DESCRIPTION OF THE DRAWINGS

Further characteristics and advantages of the present invention will become more apparent hereinafter from the following detailed disclosure of a preferred, though not exclusive, embodiment of an improved bag, case, trolley case and the like according to the invention, which is illustrated, by way of an indicative, but not limitative, example in the accompanying drawings, where:

FIG. 1 is a schematic perspective view showing the improved bag, case, trolley case and the like, in which the current generator and battery unit are separated from one another;

FIG. 2 is a front elevation view showing the subject improved bag, case, trolley case and the like;

FIG. 3 is a side elevation view showing the subject improved bag, case, trolley case and the like during the use of the latter; and

FIGS. 4 and 5 are detail views showing details of the devices constituting the electric current source wheel assemblies, together with the battery unit applied to the subject device.

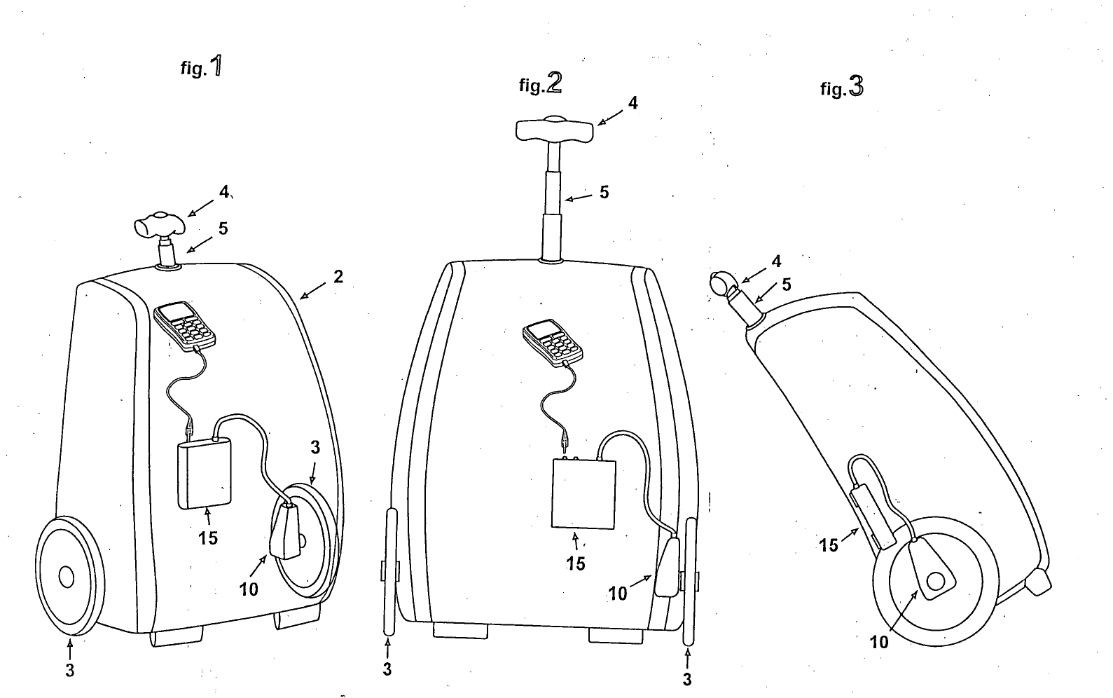

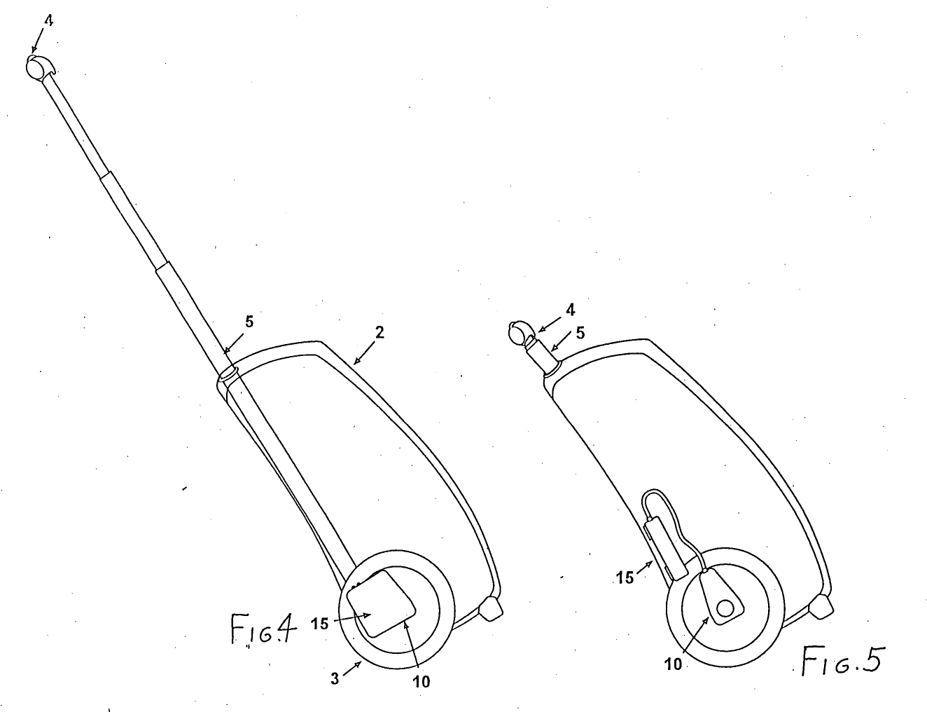

### DESCRIPTION OF THE PREFERRED EMBODIMENT

With reference to the number references of the above mentioned figures, the improved bag, case, trolley case and the like, which has been generally indicated by the reference number 1, comprises a containing body 2 which can be made with any desired configuration and starting from any desired materials, such as a fabric, plastic, metal material, and comprising a plurality of wheels 3 which can be arranged as desired.

Moreover, said body 2 further comprises conventional a gripping element or handle 4 and gripping rod 5, to be gripped by the bag, case, trolley case user and the like.

The main feature of the invention is that, coupled to at least a wheel 3, is provided an electric current generator or source 10 which, advantageously, comprises a dynamo, allowing at least an electric component to be directly applied thereto, said electric component comprising, for example, an electric device such as a lighting source, an electronic playback device, a computer, a phone device or the like.

The electric component can also comprise a battery or accumulator 15, allowing to accumulate therein the electric power produced as the bag, case, trolley case is operated or driven on a surface, the stored energy being provided for a delayed use.

The accumulator, comprising a conventional rechargeable battery, can be either stably or removably coupled, and being arranged in a dedicated housing defined on the trolley case.

From the above disclosure it should be apparent that the invention fully achieves the intended aim and objects.

In fact, the inventive application of an electric current generator or source to a wheel of a bag, case, trolley case and the like, allows to greatly improve this fitting, and allows the user to have available, in any situations, an electric power source designed for power supplying several electronic apparatus, while allowing electric power to be accumulated for a subsequent use.

The invention, as disclosed, is susceptible to several modifications and variations, all of which will come within the scope of the invention.

Moreover, all the constructional details can be replaced by other technically equivalent elements.

In practicing the invention, the used materials, provided that they are compatible to the intended application, as well as the contingent size and shapes, can be any, depending on requirements.

1. An improved bag, case, trolley case and the like, comprising a containing body including a plurality of transfer wheels, characterized in that said bag, case and trolley case further comprises, coupled to at least a said wheel, an electric current generator for power supplying at least an electric component.

2. An improved bag, case, trolley case and the like, according to claim 1, characterized in that said electric current generator comprises a dynamo.

3. An improved bag, case, trolley case and the like, according to claim 1, characterized in that said electric component comprises an accumulator.

4. An improved bag, case, trolley case and the like, according to claim 1, characterized in that said electric component comprises an electrically powered device.

5. An improved bag, case, trolley case and the like, according to claim 3, characterized in that said electric accumulator is removably coupled to said containing body.

6. An improved bag, case, trolley case and the like, according to claim 3, characterized in that said electric accumulator is firmly coupled to said containing body.

7. An improved bag, case, trolley case and the like, according to claim 1, characterized in that said containing body comprises at least a gripping element.
